(19) United States
(12) Patent Application Publication
(10) Pub. No.: US 2010/0256591 A1
(43) Pub. Date: Oct. 7, 2010

(54) MIXING DEVICE

(75) Inventors: Phillip Phung-I HO, SANTA BARBARA, CA (US); Chung-Chieh LEE, Banciao City (TW)

Correspondence Address: PATENTTM.US, P. O. BOX 82788, PORTLAND, OR, 97282-0788, US

(73) Assignee: Phillip Phung-I HO, Santa Barbara, CA (US)

(21) Appl. No.: 12/724,249

(22) Filed: Mar. 15, 2010

(30) Foreign Application Priority Data
Apr. 1, 2009 (TW) 098110832

(51) Int. Cl. A61J 1/14

(52) U.S. Cl. 604/415; 604/416

(57) ABSTRACT

A mixing device having a body, a pusher, an abutter and a mixer is provided. The body is tubular and has a fore end, a rear end and multiple chambers. Each chamber has a fore opening, a rear opening and a cap sealing the fore opening. The cap protrudes forwardly and has an outer surface and a top. The pusher has multiple rods respectively inserted in the chambers from the rear openings. The abutter has multiple tubes for respectively breaking the caps through to communicate with the chambers and each having a blunt end. The mixer is tubular and has an outlet, a connector and a mixing shaft mounted therein. The connector is connected to the fore end of the body and communicates with the tubes of the abutter. The cap may be easily injection-molded and agents may be filled directly into the chambers to ensure reliable operation.

### BACKGROUND OF THE INVENTION

1. Field of the Invention

The present invention relates to a mixing device, especially to a device for mixing more than two agents into a pharmaceutical composition.

2. Description of the Prior Art

Various dental or surgical pharmaceutical compositions need to be made right before use to prevent unexpected degradation that may cause solidification or sharp drop of medical activity. Conventional mixing devices are developed to quickly mix the agents and conveniently use the composition. As disclosed in U.S. Pat. No. 6,352,177, one of such conventional mixing devices has two holding chambers into which two cartridges are respectively inserted. To make and use a composition from the agents packed in the two cartridges, the user pierces the cartridges respectively with two piercing tubes. The agents are forwarded into a mixing chamber, where they are mixed into a pharmaceutical composition, through the tubes. The user may then output and use the composition.

However, the packing material of the cartridge may recess, instead of being pierced open at the contact with the piercing tube, and thus hold the agents which are supposed to flow into the mixing chamber. Such malfunctioning caused by an unreliable device may be harmful if not fatal in a dental or surgical event.

Furthermore, a manufacturer will find production of the conventional mixing device, which requires packing agents into cartridges and inserting the same into the holding chambers to be inefficient, especially compared with the production of injection-molded chambers immediately filled with agents. Not able to be efficiently made with the widely used injection molding technology, the conventional mixing device costs more to manufacture and is thus less competitive in the marketplace.

To overcome these shortcomings, the present invention provides a mixing device to mitigate or obviate the aforementioned problems.

### SUMMARY OF THE INVENTION

The main objective of the invention is to provide a reliable and easy-to-make mixing device.

The mixing device in accordance with the present invention has a body, a pusher, an abutter and a mixer.

The body is tubular and has a fore end, a rear end and multiple chambers. Each chamber has a fore opening, a rear opening and a cap sealing the fore opening. The cap protrudes forwardly and has an outer surface and a top.

The pusher has multiple rods respectively inserted into the chambers from the rear openings.

The abutter has multiple tubes for respectively breaking through the caps to communicate with the chambers and each having a blunt end.

The mixer is tubular and has an outlet, a connector and a mixing shaft mounted therein. The connector is connected to the fore end of the body and communicates with the tubes of the abutter.

With the aforementioned structures, the cap may be easily injection-molded and agents filled directly in the chambers to ensure reliable operation.

Other objectives, advantages and novel features of the invention will become more apparent from the following detailed description when viewed in conjunction with the accompanying drawings.

### BRIEF DESCRIPTION OF THE DRAWINGS

FIG. 1 is a perspective view of a first embodiment of the mixing device in accordance with the present invention;

FIG. 2 is an exploded perspective view of the mixing device in FIG. 1;

FIG. 3 is a sectional side view of the mixing device in FIG. 1;

FIG. 4 is an operational side view in partial section of the mixing device in FIG. 1;

FIG. 5 is a side view in partial section of the body of the mixing device in FIG. 1;

FIG. 6 is a front view of the mixing device in FIG. 1;

FIG. 7 is a perspective view of a second embodiment of the mixing device in accordance with the present invention;

FIG. 8 is an exploded perspective view of the mixing device in FIG. 7;

FIG. 9 is a sectional side view in partial section of the mixing device in FIG. 7;

FIG. 10 is an operational side view in partial section of the mixing device in FIG. 7;

FIG. 11 is a side view in partial section of the body of the mixing device in FIG. 7;

FIG. 12 is a side view in partial section of a third embodiment of the mixing device in accordance with the present invention;

FIG. 13 is a side view in partial section of a forth embodiment of the mixing device in accordance with the present invention;

FIG. 14 is an enlarged and exploded perspective view of a fifth embodiment of the mixing device in accordance with the present invention; and

FIG. 15 is a perspective view of a sixth embodiment of the mixing device in accordance with the present invention.

### DETAILED DESCRIPTION OF THE PREFERRED EMBODIMENTS

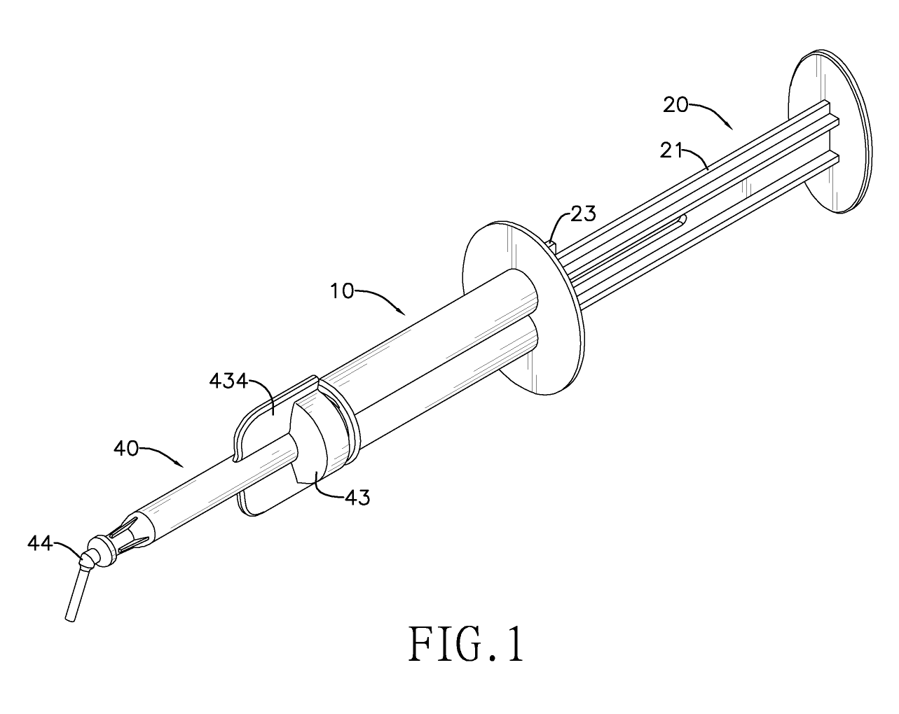

With reference to FIGS. 1-3, a first embodiment of the mixing device in accordance with the present invention comprises a body (10), a pusher (20), an abutter (30) and a mixer (40).

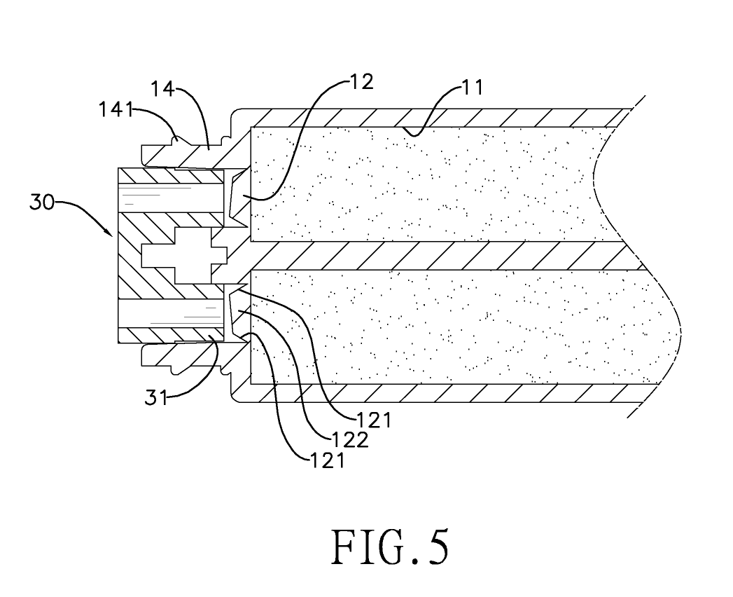

The body (10) is tubular and comprises a fore end, a rear end, an outer surface and multiple chambers (11). Each chamber (11) comprises a fore opening, a rear opening and a cap (12). The fore opening and the rear opening of the chamber (11) respectively correspond to the fore end and rear end of the body (10). With reference to FIG. 5, the cap (12) is mounted to and seals the fore opening of the chamber (11), protrudes forwardly and comprises an outer surface and a top. The cap (12) is used to seal an agent (60) within the chamber (11) preventing leakage of the agent (60) from the fore opening of the chamber (11). The cap (12) is preferably injection-molded to the fore opening of the chamber (11).

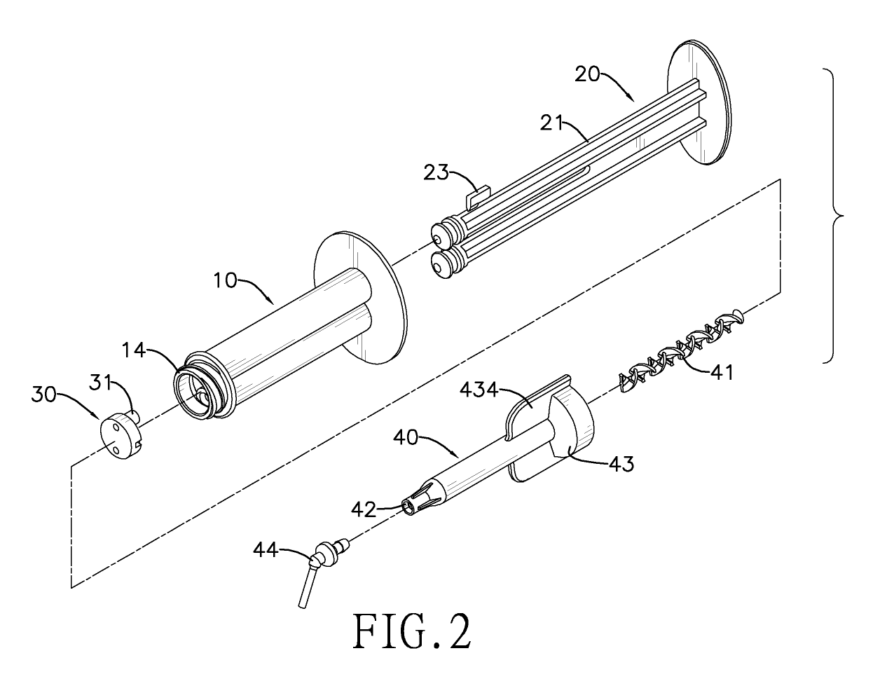

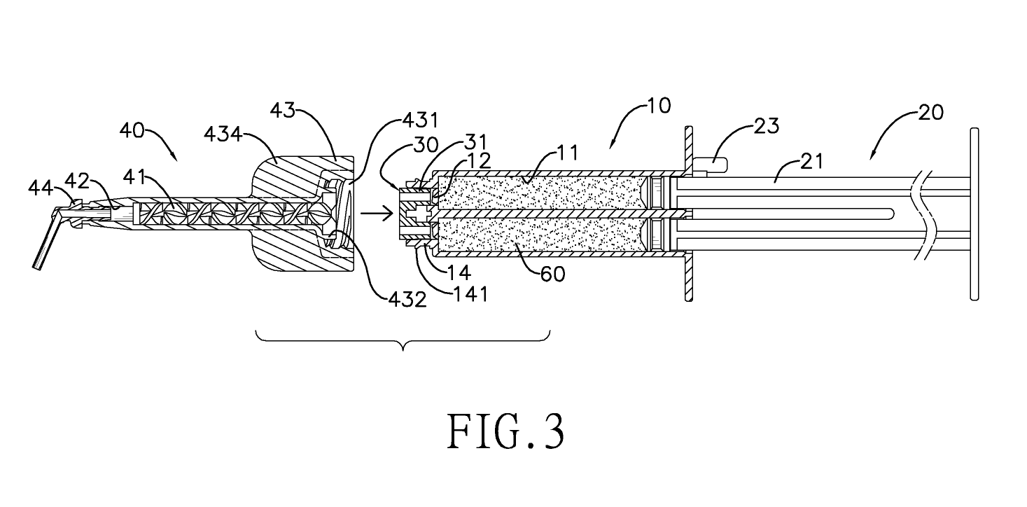

With reference to FIGS. 2 and 3, the pusher (20) has multiple rods (21). The rods (21) are to be respectively inserted in the chambers (11) from the rear openings. When the user pushes the rods (21), the pushing force passed by the rods (21) forces the agent (60) in the chambers (11) to move forwards. Preferably, at least one of said rods (21) has a safety tab (23) attached to its side of the rod (21) to prevent accidental proceeding of the rod (21) into the chamber (11) before use. Removing the safety tab (23) from the rod (21) allows normal operation of the mixing device.

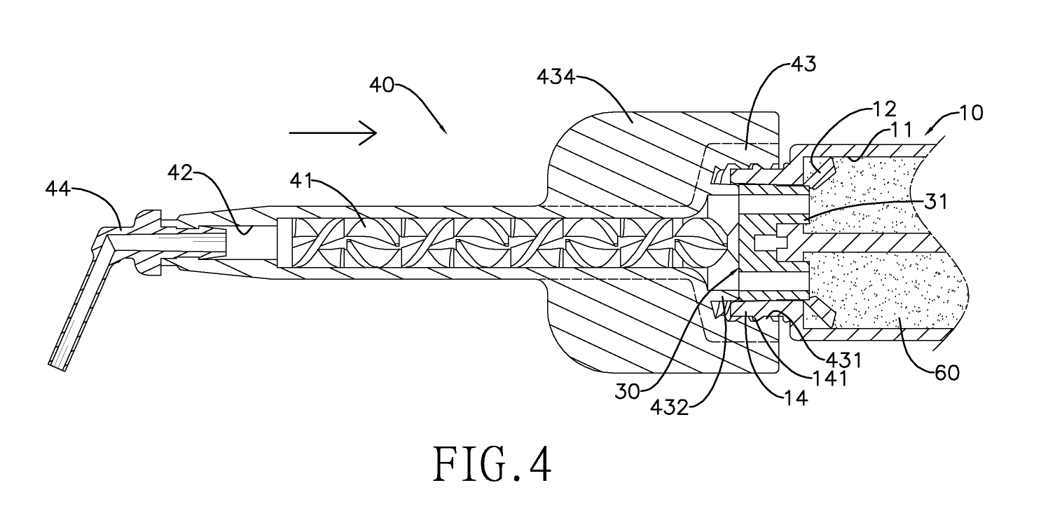

With reference to FIG. 4, the abutter (30) has multiple tubes (31) for respectively breaking the caps (12) through to communicate with the chambers (11) and each having a blunt end that contacts the cap (12). After breaking through the caps (12), the tubes (31) are respectively positioned within the fore opening of the chambers (11). The cap (12) may be injection-molded and has a structurally weak portion corresponding to the fore opening of the chamber (11) so that the tubes (31) may easily break the caps (12) through the structurally weak portion.

The mixer (40) is tubular and has an outlet (42), a connecting end, a connector (43) and a mixing shaft (41) mounted therein. The connector (43) is defined on the connecting end and connected to the fore end of the body (10) and communicates with the tubes (31) of the abutter (30).

When the caps (12) break, the user pushes the pusher (20) to apply a force with the rods (21) onto and pushes agents (60) filled in the chambers (11) forward through the tubes (31) of the abutter (30) into the mixer (40). The user then with the mixing shaft (41) mixes the agents (60) from the chambers (11) into a pharmaceutical composition that is readily expressed from the outlet (42) for use.

The outlet (42) may be modified, for example, be modified as or mounted with a nozzle (44), according to the property of the composition or for meeting specific needs. One artisan of ordinary skill in the art will understand and be able to make such modifications to the outlet (42) without escaping the scope of the present invention.

With reference to FIGS. 1 and 4, the body (10) of the first embodiment of the mixing device, in accordance to the present invention, further comprises a column (14). The column (14) protrudes forward from the fore end of the body (10) and is defined around the periphery of the fore openings of the chambers (11). The abutter (30) is received in the column (14). The connector (43) of the mixer (40) is mounted to the column (14) and connects the mixer (40) to the fore end of the body (10).

The column (14) holds the abutter (30) in intimate contact with the fore end of the body (10) for ready access to the cap (12) and keeps the abutter (30) from being wobbly or accidentally dislodged from the body (10) in order to ensure steady supply of the agents (60) into the mixer (40) through the tubes (31) of the abutter (30).

Preferably, the column (14) has an outer surface and an outer thread (141). The outer thread (141) is formed on the outer surface of the column (14). The connector (43) is columnar and has an inner surface and an inner thread (431). The inner thread (431) corresponds to the outer thread (141) and is formed on the inner surface of the connector (43) for mounting the connector (43) to the column (14), so that the connector (43) is connected to the fore end of the body (10).

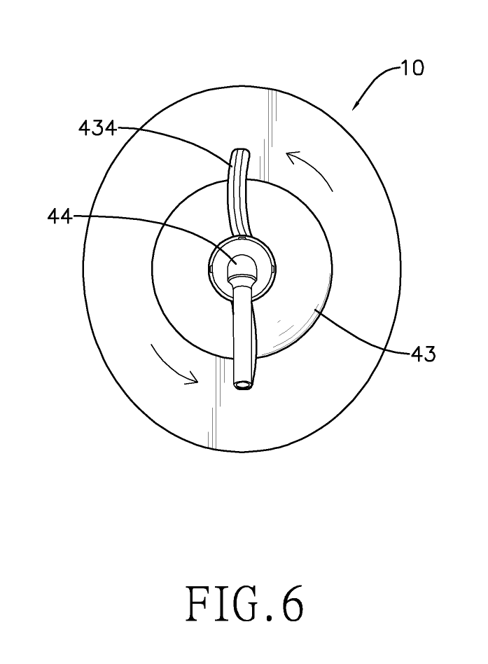

With reference to FIG. 6, the connector (43) of the mixer (40) further has multiple wings (434) for easy mounting of the connector (43) to the column (14) with the aforementioned outer thread (141) and inner thread (431).

Preferably, the connecting end of the mixer (40) pushes the abutter (30) against the body (10) to stabilize and maintain the relative positions of the abutter (30), the body (10) and the mixer (40). More preferably, the connector (43) of the mixer (40) further comprises a positioning protrusion (432) pushing the abutter (30) against the body (10). The mixing shaft (41) may extend towards the abutter (30) and have a rear end which abuts the abutter (30).

With reference to FIG. 5, as mentioned above, each of the caps (12) protrudes forwardly and comprises an outer surface (121) and a top (122). The top (122) of each of the cap (12) has an outer portion near the outer surface of the body (10) and an inner portion away from the outer surface of the body (10). The inner portion may forwardly protrude more than the outer portion of top (122). When one of the tubes (31) of the abutter (30) pushes against one of the caps (12), the blunt end of the tube (31) first contacts the inner portion of the cap (12). As the abutter (30) proceeds against the cap (12) towards the chamber (11), the inner portion of the cap (12) takes more pressure than the outer portion of the cap (12). Eventually, the inner portion of the cap (12) becomes a break point that allows the tube (31) to easily break and pass through the cap (12).

Alternative to the aforementioned structure, another embodiment of the cap (12) may have an inner portion and an outer portion forwardly protrudes more than the inner portion. When pushed by the tube (31) of the abutter (30), the outer portion contacts the blunt end of the tube (31) first and takes more pressure there from, which also leads to easy breakage of the cap (12).

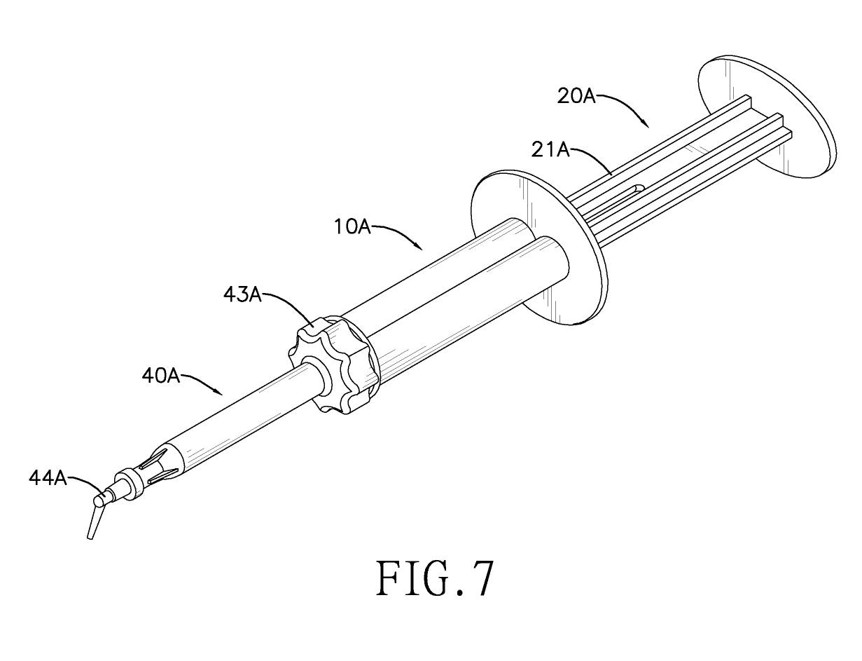

With reference to FIGS. 7-9, the second embodiment of the mixing device in accordance with the present invention also has a body (10A), a pusher (20A), an abutter (30A) and a mixer (40A).

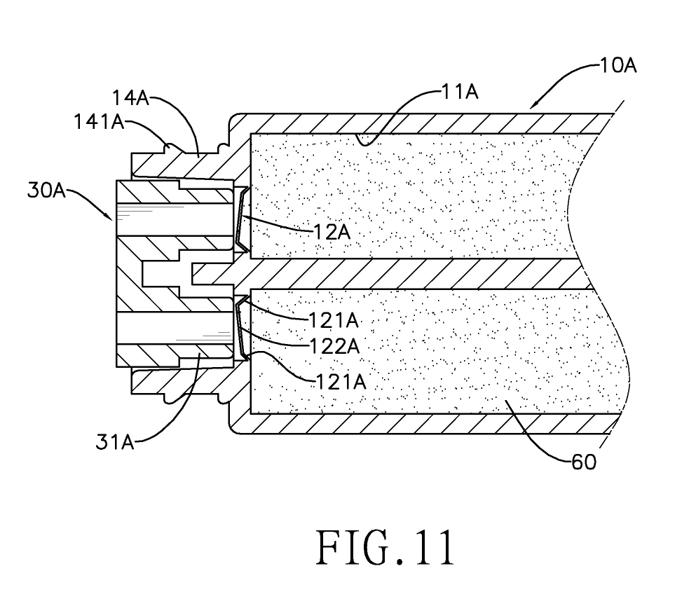

The body (10A) is tubular and has a fore end, a rear end and multiple chambers (11A). Each chamber (11A) has a fore opening, a rear opening and a cap (12A). The fore opening and the rear opening respectively correspond to the fore end and rear end of the body (10A). With reference to FIG. 11, the cap (12A) is injection-molded and mounted to and seals the fore opening of the chamber (11A). The cap (12A) protrudes forwardly and comprises an outer surface (121A) and a top (122A).

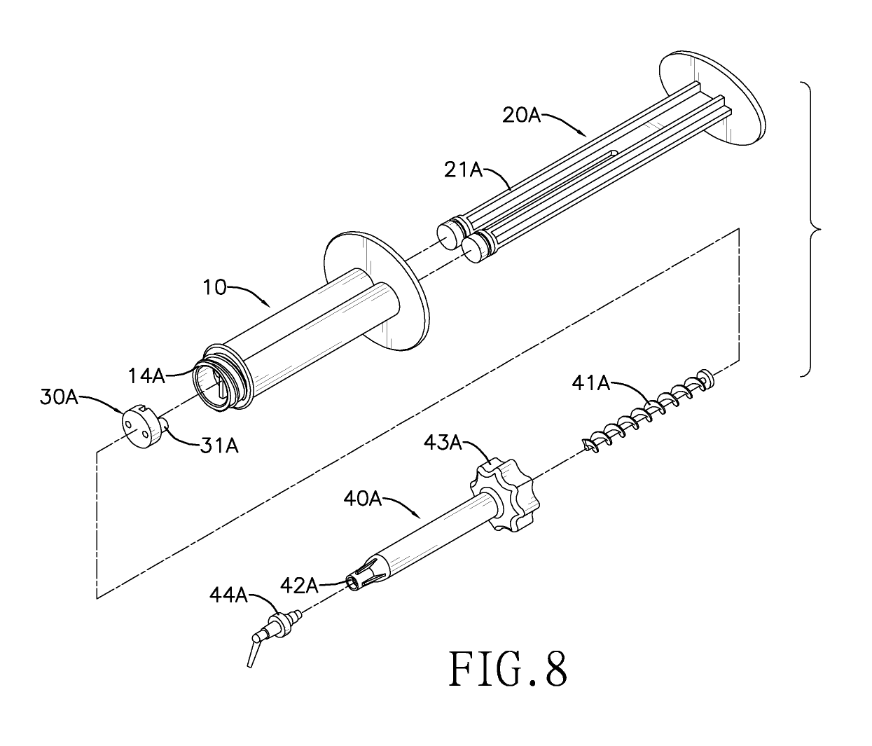

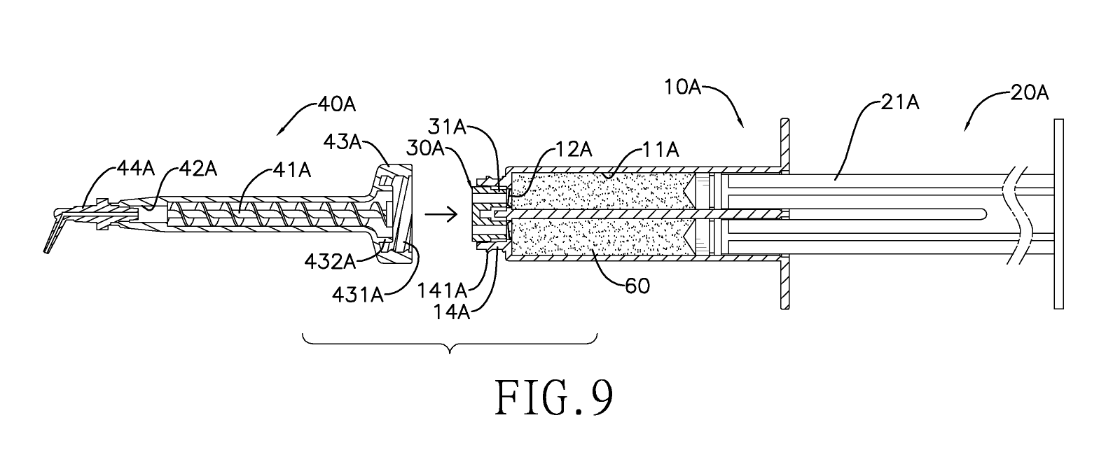

With further reference to FIGS. 8 and 9, the pusher (20A) of the second embodiment of the mixing device has multiple rods (21A). The rods (21A) are respectively inserted in the chambers (11A) from the rear opening thereof for pushing the agents (60) filled in the chambers (11A) forwards.

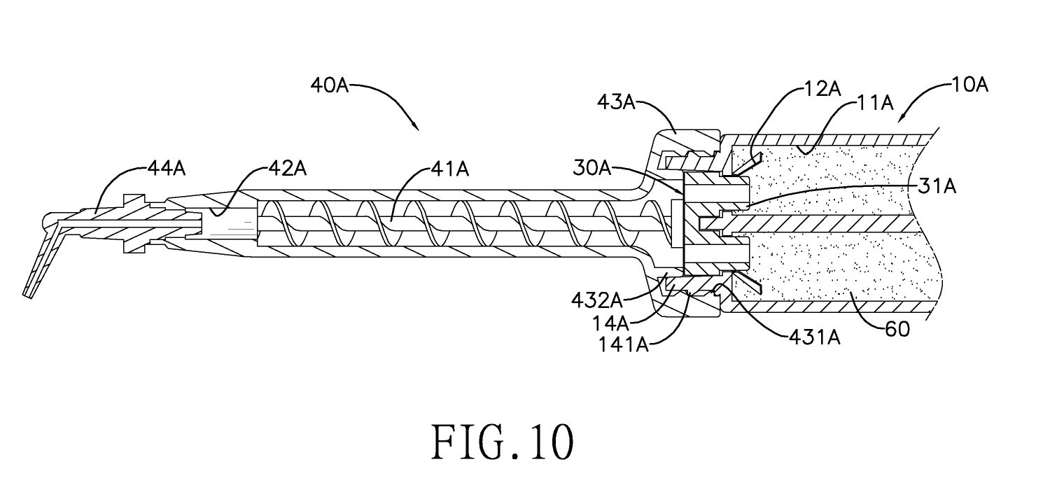

With reference to FIG. 10, the abutter (30A) also has multiple tubes (31A) respectively pointing to the chambers (11A) for breaking the caps (12A) through. Each tube (31A) has a blunt end for contacting the cap (12A).

The above mentioned injection-molded caps (12A) are structurally stronger than conventional agent-packing materials and each has a predefined shape. When pushed by the tubes (31A), the caps (12A) break crisply without generating recesses that may tolerate the pushing tubes (31A).

The mixer (40A) has an outlet (42A), a connecting end, a connector (43A) and a mixing shaft (41A). The mixing shaft (41A) is mounted within the mixer (40A). The connector (43A) is defined on the connecting end and connected to the fore end of the body (10A) and communicates with the tubes (31A) of the abutter (30).

With reference to FIGS. 7 and 10, the body (10A) of the second embodiment of the mixing device further comprises a column (14A). The column (14A) protrudes forwards from the fore end of the body (10) and is defined around the periphery of the fore openings of the chambers (11A). The abutter (30A) is received in the column (14A). The connector (43A) of the mixer (40A) is mounted to the column (14A) and connected to the fore end of the body (10A).

The column (14A) holds the abutter (30A) in front of the fore end of the body (10A) for readily access to the cap (12A) and keeps the abutter (30A) from wobbly or accidentally dislodged from the body (10A) to ensure steady supply of the agents (60A) into the mixer (40A) through the tubes (31A) of the abutter (30A).

Preferably, the column (14A) has an outer surface and an outer thread (141A). The outer thread (141A) is formed on the outer surface of the column (14A). The connector (43A) has an inner surface and an inner thread (431A). The inner thread (431A) is formed on the inner surface of the connector (43A) for mounting the connector (43A) to the column (14A), so that the connector (43A) is connected to the fore end of the body (10A).

Preferably, the connecting end of the mixer (40A) pushes the abutter (30A) against the body (10A) to stabilize and maintain the relative positions of the abutter (30A), the body (10A) and the mixer (40A). More preferably, the connector (43A) of the mixer (40A) further comprises a positioning protrusion (432A) pushing the abutter (30A) against the body (10A). The mixing shaft (41A) extends towards the abutter (30A) and has a rear end for pushing the same.

With reference to FIG. 11, as mentioned above, each of the caps (12A) protrudes forwardly and comprises an outer surface (121A) and a top (122A). The structure of the cap (12A) may be modified or arranged. The embodiments of the cap (12A) disclosed herein are for demonstrating the relevant art and not in any aspect limiting the scope of the present invention.

The top (122A) of each of the cap (12A) has an outer portion near the outer surface of the body (10A) and an inner portion away from the outer surface of the body (10A). The inner portion may forwardly protrude more than the outer portion of top (122A). When one of the tubes (31A) of the abutter (30A) pushes against one of the caps (12A), the blunt end of the tube (31A) first contact the inner portion of the cap (12A). As the abutter (30A) proceeds against the cap (12A) towards the chamber (11A), the inner portion of the cap (12A) takes more pressure than the outer portion of the cap (12A). Eventually, the inner portion of the cap (12A) becomes a breaking point that allows the tube (31A) to easily break and pass through the cap (12A).

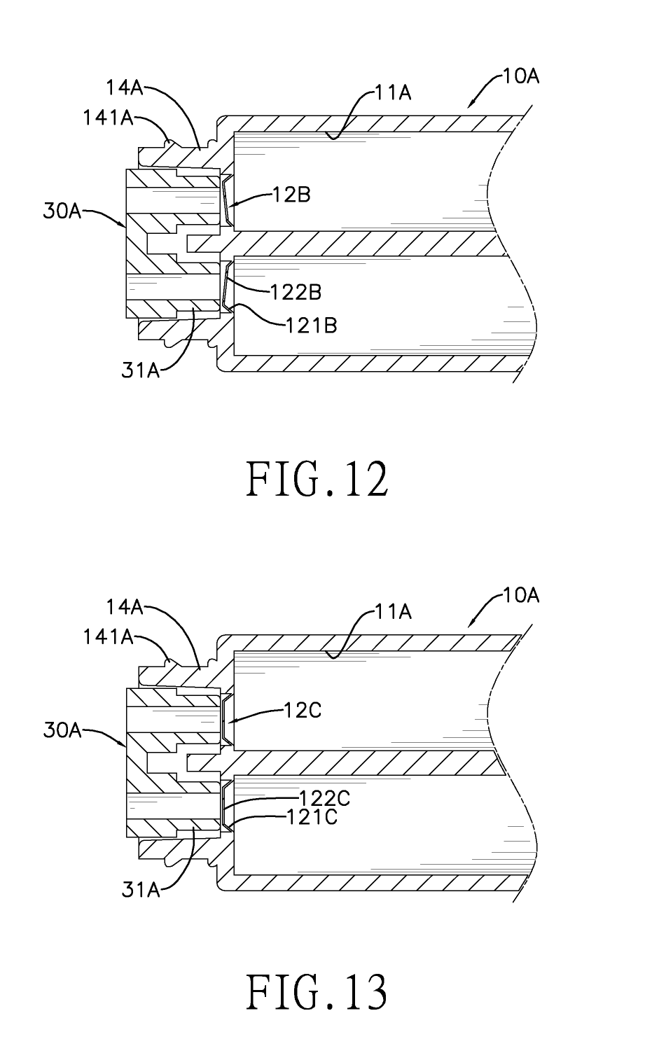

With reference to FIG. 12, the top (122B) of each of the caps (12B) of the third embodiment of the mixing device has an outer portion near the outer surface of the body (10A) and an inner portion away from the outer surface of the body (10A). The outer portion forwardly protrudes more than the inner portion. When pushed by the tube (31B) of the abutter (30B), the outer portion contacts the blunt end of the tube (31B) first and takes more pressure therefrom, which also leads to easy breakage of the cap (12B).

With reference to FIG. 13, the top (122C) of each of the caps (12C) of the forth embodiment of the mixing device is flat and even. In other words, the portions of the top (122C) evenly protrude forwards. Consequently, the tube (31C) of the abutter (30C) evenly contacts the flat top (122C) of the cap (12C). The caps (12C) of the fourth embodiment of the mixing device provide no significant breaking point as the above mentioned embodiments. However, a breakage will take place at random position of the structurally weak boundary line between the outer surface (121C) and the top (122C) of the cap (12C), when the cap (12C) is pushed by the tube (31C). Thus the tubes (31C) of the abutter (30C) of the forth embodiment of the mixing device are able to break through the caps (12C) effectively.

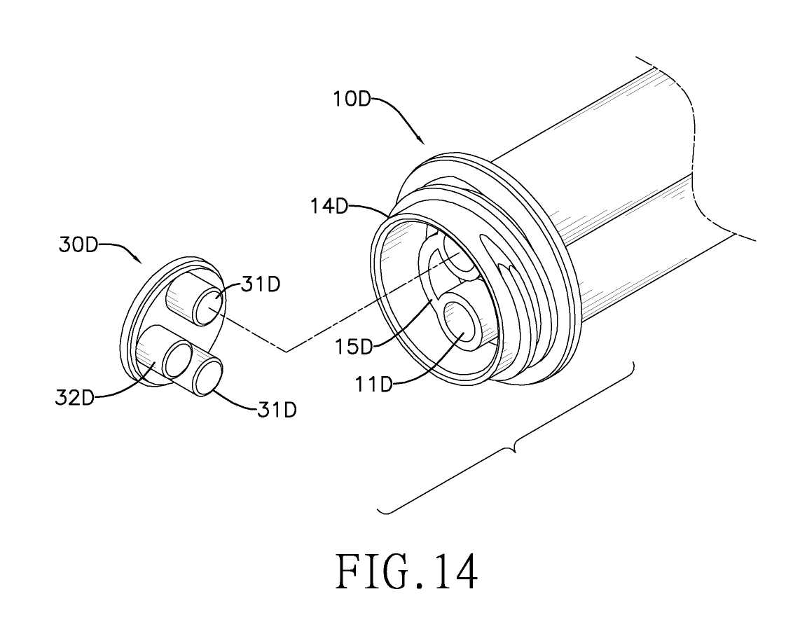

With reference to FIG. 14, the abutter (30D) of the fifth embodiment of the mixing device in accordance with the present invention further comprises a fool-proof protrusion (32D), and the body (10D) further comprises a fool-proof block (15D). The fool-proof block (15D) blocks the fool-proof protrusion (32D) to prevent the abutter (30D) from being held in the column (14D) when the abutter (30D) is not properly orientated, which ensures the tubes (31D) to align with the chambers (11D) of the body (10D).

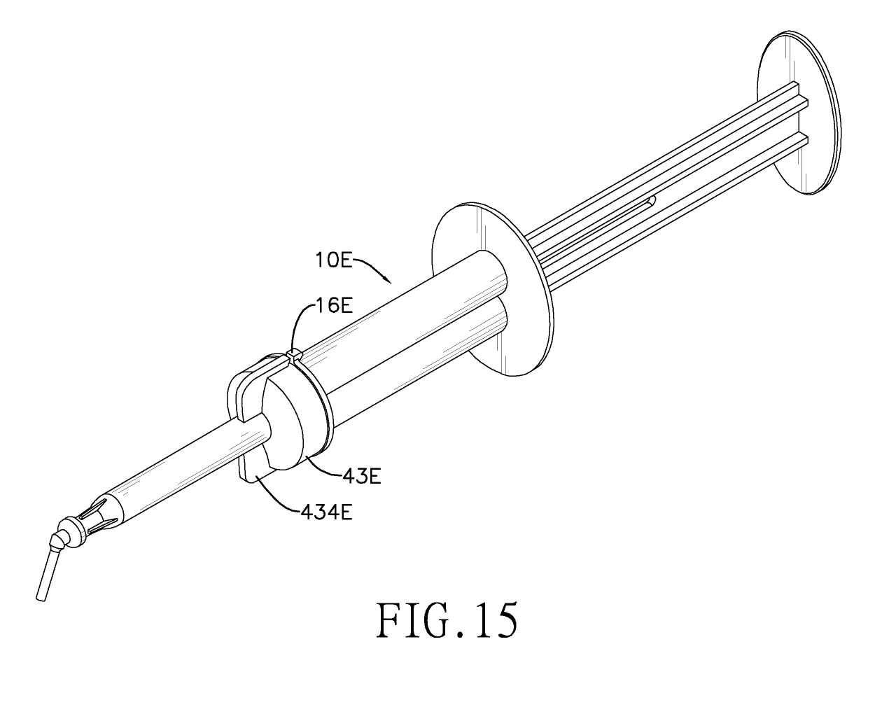

With reference to FIG. 15, the body (10E) of the sixth embodiment of the mixing device in accordance with the present invention comprises multiple wings (434E) for mounting the connector (43E) easily to the body (10E) and further comprises a positioning element (16E). The positioning element (16E) is attached to the outer surface of the body (10E) to indicate proper tightness of the connector (43E) mounted to the body (10E) by aligning to one of the wings (434E).

With the aforementioned structures, the mixing device in accordance with the present invention ensures reliable operation and is easy to make.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A mixing device comprising:
a body being tubular and comprising
a fore end;
a rear end;
an outer surface; and
multiple chamber each comprising
a fore opening corresponding to the fore end of the body;
a rear opening corresponding to the rear end of the body; and
a cap protruding forwardly, sealing the fore opening and comprising
an outer surface; and
a top;
a pusher comprising
multiple rods respectively inserted in the chambers of the body from the rear openings of the chambers;
an abutter comprising
multiple tubes for respectively breaking the caps through to communicate with the chambers and each comprising
a blunt end; and
a mixer being tubular and comprising
an outlet;
a connecting end;
a connector connected to the fore end of the body and communicating with the tubes of the abutter; and
a mixing shaft mounted therein.

2. The mixing device as claimed in claim 1, wherein
the body further comprises
a column protruding forwards from the fore end of the body, defined around the periphery of the fore openings of the chambers, holding the abutter and connecting the mixer to the fore end of the body.

3. The mixing device as claimed in claim 2, wherein
the column comprises
an outer surface; and
an outer thread formed on the outer surface of the column; and
the connector is columnar and comprises
an inner surface; and
an inner thread corresponding to the outer thread of the column and formed on the inner surface of the connector.

4. The mixing device as claimed in claim 3, wherein
the connecting end of the mixer pushes the abutter against the body.

5. The mixing device as claimed in claim 4, wherein
the connector of the mixer further comprises
a positioning protrusion pushing the abutter against the body.

6. The mixing device as claimed in claim 4, wherein
the mixing shaft extending towards the abutter and comprises
a rear end for pushing the abutter.

7. The mixing device as claimed in claim 1, wherein
the top of each cap comprises
an outer portion near the outer surface of the body; and
an inner portion away from the outer surface of the body forwardly protruding more than the outer portion of the top of the cap.

8. The mixing device as claimed in claim 1, wherein
the top of each cap comprises
an inner portion away from the outer surface of the body; and
an outer portion near the outer surface of the body forwardly protruding more than the inner portion of the top of the cap.

9. The mixing device as claimed in claim 1, wherein
the top of the cap is flat and even.

10. The mixing device as claimed in claim 1, wherein
the abutter further comprises a fool-proof protrusion; and
the body further comprises a fool-proof block for blocking the fool-proof protrusion (32D) when the abutter is not properly orientated.
